(19) United States
(12) Patent Application Publication
(10) Pub. No.: US 2026/0284747 A1
(43) Pub. Date: Sep. 24, 2026

(54) THERMAL ANALYSIS FOR A PART MANUFACTURED BY ADDITIVE MANUFACTURING BY STUDYING THE PATHS OF TOOLS

(71) Applicant: SAFRAN ADDITIVE MANUFACTURING CAMPUS, LE HAILLAN (FR)

(72) Inventors: Yaasin MAYI, MOISSY-CRAMAYEL (FR); Xavier, Roger BETBEDER-LAÜQUE, MOISSY-CRAMAYEL (FR)

(73) Assignee: SAFRAN ADDITIVE MANUFACTURING CAMPUS, LE HAILLAN (FR)

(21) Appl. No.: 19/474,398

(22) PCT Filed: Apr. 11, 2024
(86) PCT No.: PCT/FR2024/050479

§ 371 Date: Oct. 30, 2025

(30) Foreign Application Priority Data
Apr. 13, 2023 (FR) 2303692

(51) Int. Cl. B22F 10/85; B22F 10/28; B22F 10/36; B33Y 30/00; B33Y 50/02

(52) U.S. Cl. CPC B22F 10/85; B22F 10/28; B22F 10/36; B33Y 30/00; B33Y 50/02

(57) ABSTRACT

The invention relates to a method for determining the thermal behaviour of a part for production by additive manufacturing by means of at least one tool, comprising, for a set of points of a path of the tool intended for the production, steps of: —determining (S1) values of a set of primary parameters relating to the production by additive manufacturing; —determining (S4, S5) values of a reduced set of dimensionless parameters, as a function of the values of the set of primary parameters and a correlation function linking the dimensionless parameters; —generating (S6) a heat map for at least one layer of the part, as a function of the dimensionless parameters; —determining at least one risk zone within the heat map; and—adapting at least one parameter of the tool (200) as a function of the at least one risk zone, the at least one parameter optionally being a parameter of the path.

### FIELD OF THE INVENTION

The present invention concerns additive manufacturing (or printing) and in particular the simulation and optimization of the thermal behavior of a part produced by additive manufacturing.

Additive manufacturing (AM), or 3D printing, is a family of processes in which parts are produced by successive additions of layers of materials.

The parts produced can be of different natures, different dimensions and varying complexity. Some parts must also meet strict specifications and may be subject to certification. By way of example, in the aeronautical field, additive manufacturing may concern high or low pressure distributors for turbomachines, turbomachine rectifier vanes, injectors, casings, heat exchangers, hydraulic blocks, etc.

In general, any additive manufacturing process by melting or consolidating material (metal, polymer, ceramic, etc.) by successive or simultaneous applications of one or more heat sources supplied by tools along a given path can be considered. These tools may in particular be lasers.

The processes currently available include
powder bed laser sintering processes, such as selective laser sintering (SLS),
laser powder bed fusion processes, such as, for example, selective laser melting (SLM), laser beam melting (LBM), laser powder bed fusion (LPBF, direct metal laser sintering (DMLS), etc.
electron beam powder bed melting processes, such as electron beam melting (EBM), electron powder bed fusion (EPBF), etc.

In particular, in laser powder bed fusion processes (SLM, LBM, LPBF, DMLS, etc.), the parts are manufactured by laser fusion and solidification of a succession of powder layers.

For each layer, a scraper spreads a bed of metal powder of fixed thickness. Then a laser whose movement is controlled melts only the surface corresponding to the section of the part to be constructed, scanning this surface along a path set by the operator (see below). This part of the operation is often called “lasing”. The molten powder resolidifies after the laser passes and the solid surface is thus created. The platform is then lowered by the thickness of the new layer of powder that will be spread, and the process is repeated until the part is completely produced. The power, speed and focus plane of the laser are controlled throughout the process. These parameters determine the width and depth of the melted area when the laser passes (called the “laser bead”).

The laser path is also set by the operator. This laser path is also called a laser pattern, scan pattern or vectorization strategy. This path is predefined during the preparation phase for computer aided manufacturing (CAM).

The state of the material is strongly impacted by the thermal cycles imposed by the passage of the laser beam, and successive cooling. These thermal cycles can thus cause various defects in the material and the part being manufactured: porosity, cracking, non-planar surface, etc.

Proposals have been made to determine the thermal behavior of a part during manufacture, especially upstream of its manufacture.

However, tools for evaluating the thermal behavior of a part beforehand encounter limitations related to the scale effects associated with additive manufacturing processes, and especially with laser powder bed fusion processes such as the LPBF process.

Thus, there are digital tools capable of finely simulating the thermal history of the process at the scale of a few beads, or even at the scale of a layer, with relatively high associated computation times (from a few hours to a few tens of hours per layer and per part). There are also tools that make it possible to estimate macroscopic temperature fields during manufacturing in a few hours, but with simplifying assumptions (for example homogeneous heat source at the scale of a layer) that do not account for the local effects that one wishes to analyze and therefore do not allow anticipating anomalies of the product during manufacturing with sufficient precision and fineness.

Mention may be made, by way of example, of patent application EP3318352 which describes a method of detecting areas of thermally critical components.

This has the disadvantage of relying on the geometric description of the part to be manufactured. When the part is large and complex, descriptive data can become very cumbersome to manage and generate computation times incompatible with industrial constraints. Furthermore, relying on the geometric description of a part necessarily implies that the simulation is only valid for that part and therefore cannot properly take into account laser paths when several parts are manufactured simultaneously.

Moreover, the energy supply strategy is not considered (laser path, possible presence of several lasers, etc.). Thermal modeling is therefore very macroscopic and does not allow an accurate and efficient prediction of anomalies related to the thermal behavior of the part, in a limited modeling time allowing a reduction in modeling and manufacturing cycle times.

There is therefore a need to improve the current proposals of the state of the art.

### SUMMARY OF THE INVENTION

To these ends, according to a first aspect, the present invention can be implemented by a method of determining the thermal behavior of a part with a view to production by additive manufacturing using at least one tool, comprising, for a set of points of a path of said tool intended for said production, steps implemented by a processing unit of an optimization device of:
determining values of a set of primary parameters relating to said additive manufacturing production;
determining values of a reduced set of dimensionless parameters, as a function of the values of said set of primary parameters and a correlation function linking said dimensionless parameters;
generating a heat map for at least one layer of said part, as a function of said dimensionless parameters, said heat map being recorded in digital format and associating a value representative of a temperature with said points;
determining at least one risk zone within said heat map;
adapting at least one parameter of said tool (200) as a function of said at least one risk zone, said at least one parameter optionally being a parameter of said path.

The invention proposed here does not necessarily exploit the geometric model of the analyzed part(s) (“heavy” data), but rather only the file(s) describing the paths taken by the tool(s) during manufacturing (“light” data).

As a result, the calculation method faithfully integrates the manufacturing sequence of the manufactured part(s) without simplifying the mode of energy deposition (in other words, the exact mode of production of the parts is taken into account) and allows thermal analyses to be produced in calculation times compatible with industrial constraints. For example, a heat map calculation representing hot spots can be obtained in a time of approximately one second per powder layer (for a laser powder bed fusion process).

Thus, the proposed method makes it possible to generate heat maps, and therefore to carry out diagnostics, on the scale of entire platforms and the improvement, or even optimization, of production by additive manufacturing, by adapting at least one parameter of the tool, on this same scale. The method therefore allows a quite substantial scale-up compared to the solutions of the prior art (which generally only deal with a weld bead, for example).

Finally, the calculation method is said to be universal, i.e. it adapts in a self-consistent manner to the particular conditions of the parts analyzed.

According to preferred embodiments, the invention comprises one or more of the following characteristics which may be used separately or in partial combination with each other or in total combination with each other:
determinations of values of a set of primary parameters and of values of a reduced set of dimensionless parameters are made from a modeling based on a set of representative elementary volumes, said heat map being generated from a value associated with each representative elementary volume;
said determination of values of a reduced set of dimensionless parameters comprises determining a subset of dimensionless parameters from said primary parameters and determining a dimensionless parameter dependent on a temperature rise from said subset and the correlation function, said dimensionless parameter dependent on a temperature rise being included in the determined reduced set of dimensionless parameters.
said correlation function is estimated by varying values for the primary parameters of the set of primary parameters and simulating an associated temperature rise.
said simulation is carried out on the scale of representative elementary volumes associated with each simulation point
said primary parameters may especially relate to said path provided for the production, and/or to the material used for this production, and/or to said at least one tool.
said at least one tool is at least one laser and said primary parameters comprise an irradiance of said at least one laser and/or a cumulative exposure time and/or a lasing time and/or a dense material depth and/or an equivalent depth and/or a thermal conductivity and/or a thermal diffusivity.
there are 3 of said dimensionless parameters, π₁, π₂, π₃ and they are expressed:

$$\{ \begin{matrix}{π}_{1} = \frac{2}{\sqrt{π}} \cdot \frac{\cdot Δ {T}_{M}^{*}}{{T}_{1 D}} \\ {π}_{2} = \frac{1}{2} \cdot \frac{δ}{{b}^{′}} \\ {π}_{3} = \frac{{t}_{expo}^{cumul}}{{t}_{scan}}\end{matrix}$$

with

$${T}_{1 D} = {I}_{a b s} \cdot δ / k \cdot \sqrt{π} , Δ {T}_{M}^{*}$$

being said value representing a temperature at a point of said set, I_{abs} being said irradiance, δ being a characteristic diffusion length dependent on said thermal diffusivity, k being said thermal conductivity, b′ being said equivalent depth,

$${t}_{e x p o}^{c u m u l}$$

being said cumulative exposure time, and t_{scan} being said lasing time.
said primary parameters further comprise a lasing speed and a characteristic radius of said tool.
there are 5 of said dimensionless parameters, π₁, π₂, π₃, π₄, π₅ and they are expressed:

$$\{ \begin{matrix}{π}_{1} = \frac{2}{\sqrt{π}} \cdot \frac{Δ {T}_{M}^{*}}{{T}_{1 D}} \\ {π}_{2} = \frac{1}{2} \cdot \frac{δ}{{b}^{′}} \\ {π}_{3} = \frac{{t}_{expo}^{cumul}}{{t}_{scan}} \\ {π}_{4} = \frac{{t}_{scan} \cdot {V}_{L}}{δ} \\ {π}_{3} = \frac{{R}_{L}}{δ}\end{matrix}$$

with

$${T}_{1 D} = {I}_{a b s} \cdot δ / k \cdot \sqrt{π} , Δ {T}_{M}^{*}$$

being said value representing a temperature at a point in said set, I_{abs} being said irradiance, δ being a characteristic diffusion length dependent on said thermal diffusivity, k being said thermal conductivity, b′ being said equivalent depth,

$${t}_{expo}^{cumul}$$

being said cumulative exposure time, t_{scan} being said lasing time, R_{L} being said characteristic radius and V_{L} being said lasing speed;
said adaptation is carried out individually for at least one segment of said path;
said adaptation comprises an adaptation of one or more of the following parameters: a power of a laser of said tool, a lasing speed, a pause time between two segments of said path, an order of the segments of said path, the length of said segments, an arrangement of said path, a geometry of the part;
said adaptation comprises a modification of a data structure expressing said path, said data structure being intended to be provided to said tool.

According to another aspect, the invention concerns a computer program comprising instructions for implementing a method as described above.

According to another aspect, the invention concerns a system comprising a machine (200) for production by additive manufacturing using at least one tool, adapted to produce a part from a path of said tool, and comprising an optimization device configured to implement the steps of:
determining values of a set of primary parameters relating to said additive manufacturing production;
determining values of a reduced set of dimensionless parameters, as a function of the values of said set of primary parameters and a correlation function linking said dimensionless parameters;
generating a heat map for at least one layer of said part, as a function of said dimensionless parameters, said heat map being recorded in digital format and associating a value representative of a temperature with said points;
determining at least one risk zone within said heat map;
adapting at least one parameter of said machine (200) as a function of said at least one risk zone, said at least one parameter optionally being a parameter of said path.

According to one embodiment, said machine is adapted to produce a part among a high or low pressure distributor for a turbomachine, a turbomachine rectifier vane, an injector, a casing, a heat exchanger, a hydraulic block, etc.

Other characteristics and advantages of the invention will become apparent on reading the following description of a preferred embodiment of the invention, given by way of example and with reference to the attached drawings.

### BRIEF DESCRIPTION OF THE FIGURES

The accompanying drawings illustrate the invention:

FIG. 1 schematically illustrates a system according to one embodiment of the invention, comprising a machine for production by additive manufacturing.

FIG. 2 schematically shows a flowchart of the steps of a method according to an embodiment of the invention.

FIGS. 3a and 3b illustrate examples of representative elementary volumes.

FIG. 4 is a very schematic illustration of a heat map.

FIG. 5 illustrates an example of a correlation function.

### DETAILED DESCRIPTION OF EMBODIMENTS OF THE INVENTION

The proposed method applies to various printing or additive manufacturing (or 3D printing) techniques. In general, additive manufacturing involves the travel of one or more tools along a predefined path (which can be called a “tool path”) to provide a point source of heat on a material.

The method is particularly applicable to laser powder bed fusion processes, and more specifically, but not exclusively, to laser powder bed fusion (LPBF).

This method makes it possible to manufacture parts from the selective melting of successively stacked powder bed layers. It makes it possible to manufacture lighter complex parts such as thin structures (lattice type) and is therefore applicable to the aeronautics field.

It is noted that the metallurgical and mechanical state (phases present, residual stresses, etc.), the health of the material (degree of porosity, cracking, etc.), the surface state, and therefore the thermomechanical properties of the resulting parts are determined in the first order by the thermal cycles imposed by the additive manufacturing process.

It is therefore essential to understand the influence of heating/cooling cycles on the thermal behavior observed in the parts in order to be able, if necessary, to optimize the manufacturing parameters to eliminate, or reduce, the harmful effects.

In the particular case of an LPBF process, the thermal cycles are controlled by the vectorization (or laser) paths imposed on each layer. Depending on these lasing strategies and the local geometric configuration of the part, hot spots can develop, linked to too much energy input compared to the part's capacity to dissipate heat locally. This is the case, for example, in areas with small cross-sections where the laser makes numerous back and forth trips in a relatively short period of time and/or in areas with undercut overhanging powder masses which have a relatively low thermal diffusivity compared to that of dense material.

These “hot spots” should be avoided because:
Heat build-up in a localized area can cause coalescence of the molten pools, which form a protrusion during solidification. When this local excess thickness exceeds the thickness of the powder layer, the scraping system can collide with the part being manufactured, which can cause a degradation of the manufactured geometry or even a manufacturing shutdown. Consequently, the melted material is lost and the industrial cycle times are lengthened.
Hot spots can promote cracking phenomena (solidification cracking or macroscopic cracking).
Overheating zones can promote the formation of unstable keyholes which, when collapsing, form porosities in the part.

In order to anticipate the appearance of these hot spots, it is proposed to carry out numerical modeling and simulations before the actual manufacturing.

Indeed, by simulating the input of heat, or energy, in a part produced by additive manufacturing, and taking into account vectorization (or laser) patterns, we can evaluate beforehand the evolution of the thermal field during manufacturing. It is thus possible to anticipate the appearance of overheating zones and possibly to trigger corrective actions.

The proposed method thus aims to identify risk zones, which can possibly become “hot spots” and induced by the exact lasing strategy on the parts to be produced, with a calculation time compatible with industrial constraints (i.e. a few hours at most per production platform).

The proposed method is based on the laser strategy, or pattern, and not, like some proposals of the state of the art, on the geometry of the parts to be produced. This makes it possible, on the one hand, to drastically reduce the computation time required while maintaining a high precision in the estimation of risk zones, and also to take into account the entire production platform, which can include several parts while previous proposals opt for a part-by-part approach. It is important to note that since the laser pattern is common for the entire production platform, a product-by-product approach necessarily introduces a bias in the estimation.

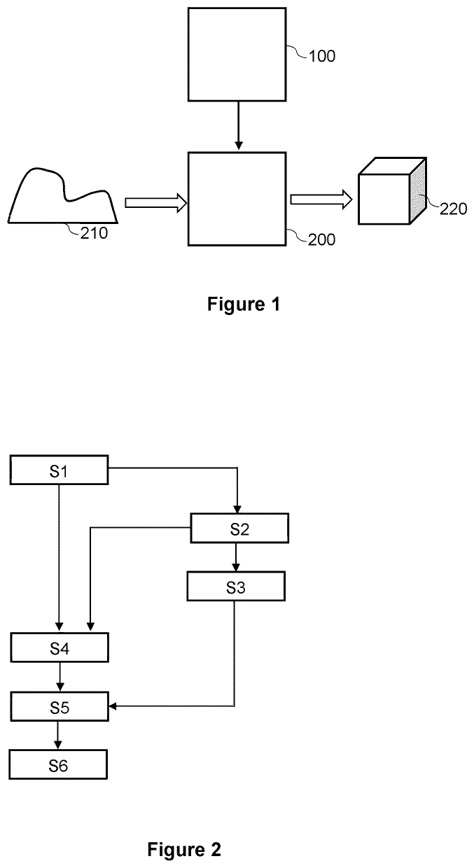

FIG. 1 schematically illustrates a context for the use of a proposed method.

A machine, or printer, 200 for additive manufacturing consumes materials 210 in order to produce one or more parts 220. This machine is parameterized by a set of parameters that specify its operation and that can be modified during manufacture: laser travel speed, laser power, etc.

In the field of aeronautics, the machine 200 can be adapted to produce parts as varied as, for example, a high or low pressure distributor for turbomachines, a turbomachine rectifier vane, an injector, a casing, a heat exchanger, a hydraulic block, etc.

An optimization device 100 is also provided and adapted for simulating the thermal behavior of a part 220 with a view to its production by additive manufacturing by means of the machine 200. This simulation is implemented upstream of production by the additive manufacturing machine and aims to determine risk zones which are especially likely to give rise to hot spots.

These risk zones can be indicated to the user. For example, a heat map can be displayed on a screen, possibly with a focus on risk zones.

As a function of the risk zones determined in the thermal behavior of the part 220 to be produced, a user can intervene on the parameters of the machine in order to avoid, or reduce, the appearance of these risk zones, or prevent these risk zones from actually becoming hot spots.

According to a particular embodiment, the simulation device can be adapted to directly determine adaptations in the set of parameters of the machine in order to optimize the additive manufacturing process in order to avoid or minimize the appearance of hot spots. In particular, heating and cooling cycles during additive manufacturing can thus be optimized by means of the results of the simulation phase.

A data structure describing the laser path or pattern can be modified before being transmitted to the additive manufacturing tool. In particular, parameters associated with one or more segments constituting this path may be adapted to reduce, or eliminate, the effects of hot spots detected by the previous steps of the method.

FIG. 2 schematically illustrates a flowchart of the proposed method.

In a step S1, the values of a set of primary parameters relating to the path of the tool or tools intended for the production of one or more parts, to the material used for this production and to the tool or tools are determined. In the case where this or these tools are lasers, the path(s) represent the laser pattern.

According to the proposed method, primary parameters are selected because they are identified as having a first-order influence on the thermal behavior at the local scale.

These parameters are of different types. They may relate to the laser(s) used, and/or to the material used (especially to these thermo-physical properties) and/or to the laser pattern.

Taken individually, these primary parameters are not necessarily sufficient to explain the thermal behavior of the part to be produced, and especially the possible appearance of hot spots.

However, by means of dimensional analysis, these parameters are combined together to form a reduced set of dimensionless and independent parameters, which have a physical significance better able to describe the thermal behavior of the part during its manufacture at the scale of the laser pattern.

At least one of these dimensionless parameters must relate to the temperature measured locally (along the tool path analyzed, for example the lasing path analyzed), while the others characterize the various factors likely to promote local overheating (undercut areas, relatively large concentration of vectors in an area, etc.).

The dimensionless character of these parameters thus makes it possible to reason from quantities independent of the specificities of the vectorization analyzed. In other words, the values of these parameters are valid regardless of the materials used or the parameters of the heat source (laser) used.

The determination of the primary parameters is based on a modeling of the additive manufacturing process and the associated laser pattern.

This modeling is carried out on a mesoscopic scale. This mesoscopic scale is intermediate between the macroscopic and microscopic scales; it is large enough to include a large number of particles (so that their statistical properties do not fluctuate significantly), while remaining fine enough for the thermodynamic quantities (pressure, temperature, etc.) to remain local (point on the macroscopic scale).

In particular, the mesoscopic scale can be defined by the influence that the laser has on a point of the laser pattern but also on points near this point, on this laser pattern, upstream or downstream.

The modeling can be based on a representative elementary volume (REV) associated with a point considered. Thus, according to this embodiment, the values of the set of primary parameters are determined from this modeling based on a set of representative elementary volumes.

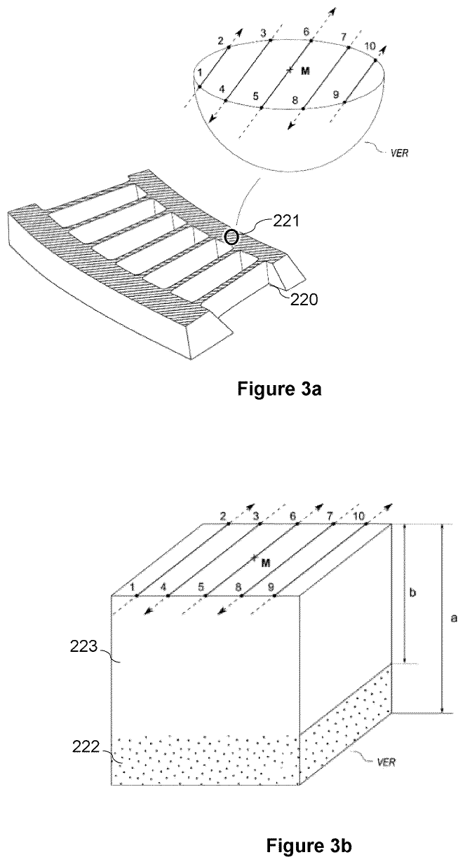

FIG. 3a and FIG. 3b illustrate examples of representative elementary volumes REV, for a point M situated on the laser pattern.

This volume is characterized by a surface centered on this point M considered, by a dimension of this surface (diameter in the example of FIG. 3a, side a in the example of FIG. 3b.

The characteristic dimension (diameter, side, etc.) has a magnitude equivalent to a few vector deviations (i.e., distance between two consecutive vectors), for example between 5 and 10 vector deviations, and contains portions of the vectors that have a thermal influence on the point M. This characteristic dimension can therefore depend on different parameters relating to the laser (power, etc.) and the material (thermal conductivity, etc.).

FIG. 3a illustrates all or a portion of a part 220 to be produced. The upper surface of this part is hatched; these hatches schematically represent the laser pattern.

This laser pattern can be seen as a set of lines corresponding to the path of the laser beam (or other heat source) at the surface of the layer of the part being manufactured.

This laser pattern, or strategy, mainly specifies the trajectory of the laser path and the inter-bead distance, that is, the distance between two neighboring (and generally parallel) lines of the laser pattern. In the figure, the lines are parallel and the inter-bead distance corresponds to the distance between two lines of the hash mark.

This laser pattern consists of a set of segments; each segment can be represented by a set of parameters: coordinates of a starting point, coordinates of an end point, laser speed, laser power, etc.

This laser pattern can be provided in a data structure which can be tabular, in which each row corresponds to a segment and the columns correspond to the different parameters associated with the segments (coordinates, laser speed, laser power, laser beam diameter, irradiance profile, etc.)

The data structure may be provided by a computer file. This file can be in various formats: TXT, G-code, CLI, CLI+, HDFS, OVF, etc.

FIG. 3a also shows a representative elementary volume REV of hemispherical shape, corresponding to a zone 221 of the part 220, and centered on a point M belonging to the laser pattern.

This representative elementary volume contains several vectors of the laser pattern. Here, the term “vector” refers to any rectilinear section which discretizes the path of the laser over the surface. The laser pattern is thus also commonly referred to as the “vectorization scheme”. It is possible during design to define curved lines for lasing, but these are usually discretized into a set of straight line segments, or vectors.

The intersection of the laser pattern with the upper surface of the representative elementary volume forms a set of segments between an entry point and an exit point (the laser pattern being oriented in the direction of the laser path).

Thus, FIG. 3a shows the oriented segments [1; 2], [3; 4], [5; 6], [7; 8], [9; 10]. Depending on the definition of a representative elementary volume, the passage of the laser over these different segments can influence the thermal behavior of the material at point M (located in the middle of the segment [5; 6]).

The representative elementary volume can have different shapes: cube, hemisphere, hemi-ellipsoid, etc., depending on its relevance to the thermal problem to be solved, and the practical constraints that this choice imposes on the implementation of the proposed method.

FIG. 3b shows another form of representative elementary volume. Its cubic shape can be characterized by a characteristic side a.

The aim of the method is to determine data representative of the thermal behavior of the part to be produced. This representative data may, for example, be a heat map for each layer of the part to be produced. This heat map can associate a value of a thermal quantity (or temperature) with each point M in which it is desired to evaluate this quantity. It is assumed, according to the proposed modeling, that this quantity depends on valid primary parameters (and assumed to be constant) on the representative elementary volume centered on the point M considered.

It is proposed to select a set of primary parameters which makes it possible to simplify the modeling as much as possible while allowing good precision in the determined thermal map (or more generally of the data representative of the thermal behavior of the part).

In other words, the set of primary parameters can be chosen so as not to rule out any important factors that may impact the thermal behavior of the material and the part to be produced.

In general, these primary parameters relating to additive manufacturing concern the predicted path of the tool for this production, the material and the tool(s) to be used as a point source of heat.

Thus, in the case of a laser, this set of primary parameters includes relative parameters:
the laser pattern planned for the production of one or more parts;
the material used for this production and;
the laser(s) (for example, power, speed, spot diameter, etc.).

It should thus be noted that the primary parameters do not relate to the geometry of the part to be produced.

It is actually observed that the geometry of the part to be produced can be extracted from the laser pattern (or more generally from the path of the tools used).

Indeed, analyzing the segments on a neighborhood makes it possible to have sufficient knowledge of the geometry of the part on this neighborhood, since the segments are present only on portions of the part. The absence of a segment on an area implicitly indicates that the area does not belong to the part to be produced.

This has the advantage of not having to take into account the files describing the geometry of the parts to be produced which are conventionally quite cumbersome, but only the file describing the lasing. This file is substantially smaller in size and easier in structure to manage, which can allow a significant gain in performance.

The proposed method comprises a prior step of determining, in a step S2, a reduced set of dimensionless parameters from these primary parameters.

According to one embodiment, the values of this reduced set of parameters of dimensionless parameters are determined from the modeling based on a set of representative elementary volumes, from which the primary parameters had previously been determined.

It is also desired that the number of dimensionless parameters be minimal. Indeed, the fewer parameters there are, the simpler the problem is, and the simpler it is to construct a chart as will be seen below. Also, according to the Vaschy-Buckingam theorem, the number of primary parameters must also be minimal.

A laser of incident irradiance I₀ travels across the upper surface of a representative elementary volume at a speed V_{L}. We can write:

$${I}_{0} = \frac{P}{π \cdot {R}_{L}^{2}}$$

with P the laser power, R_{L} the 1/e² radius of the laser beam. The constant “e” here represents e=exp(1). In this embodiment, we consider that the laser is Gaussian, that is to say that the spatial distribution of irradiance follows a two-dimensional Gaussian curve centered on the point of impact. For a Gaussian laser, the radius of the focal spot is arbitrarily defined as the radial distance from the optical axis such that the incident irradiance drops to 13.5% of the maximum irradiance, measured at the center of the spot (1/e²=0.135).

Obviously, it is possible to envisage other types of spatial distribution of the irradiance of the laser, or more generally of the heat source, around a point of impact, and to characterize this spatial distribution by a radius characteristic of the focal spot, or any other quantity or set of quantities.

The cumulative duration of laser exposure can be defined

$${t}_{expo}^{cumul}$$

as the sum of the lengths of the vector portions contained in the representative elementary volume divided by this laser speed. If there are n vectors in the representative elementary volume and these are parallel to one of its sides, we can write:

$${t}_{expo}^{cumul} = n \cdot \frac{a}{{V}_{L}}$$

However, the successive passages of the laser in the representative elementary volume are spread over time, over a duration which corresponds to the difference between the instant tout at which the laser leaves the last vector in the REV, and the instant tin at which the laser arrives on the first vector of the REV.

In the example of FIG. 3b, the instant tin corresponds to the instant at which the laser arrives at the point 1, and the instant tout corresponds to the instant at which the laser leaves the point 10. The lasing time t_{scan} corresponding to the difference between these two instants can be defined:

$${t}_{scan} = {t}_{out} - {t}_{i n}$$

Each individual laser pass is actually separated from the others by a lasing time outside the representative elementary volume considered plus a jump time between two vectors (i.e. the travel time of the laser from the end of one vector to the beginning of the next vector). Thus

$${t}_{expo}^{cumul}$$

and t_{scan} are constrained by the following inequality:

$$0 < {t}_{expo}^{cumul} \leq {t}_{scan}$$

Moreover, the representative elementary volume includes a certain quantity of dense material 223 which diffuses the heat. Potentially, it also contains a complementary quantity of powder 222 (not exposed to the laser) which acts as a thermal insulator. By simplifying the problem further, considering a unidirectional REV, b denotes the depth of dense material 223 located under the lased surface. We can write:

b≤a

In a real part, however, the dense material portions in the REVs are generally not unidirectional, especially in the draft and undercut areas. We can then consider the thickness of a thermally equivalent unidirectional element b′:

$${b}^{′} = f ( \frac{V}{S} ) .$$

V represents the volume of dense material 223 contained in the REV and S represents the reference characteristic surface (for example the irradiated upper surface, the sum of the surfaces in contact with the dense material, etc.). Moreover, the dense material has a thermal conductivity k and thermal diffusivity α assumed to be constant, while the powder 222 is assumed to be a perfect insulator (adiabatic conditions).

Finally, we can evaluate the temperature rise at point M corresponding to the REV considered by the variable

$$Δ {T}_{M}^{*} :$$

$$Δ {T}_{M}^{*} = {T}_{M}^{*} - {T}_{0}$$

$${T}_{M}^{*}$$

is a characteristic temperature at point M, resulting from the vectorization sequence. This can be the maximum or average temperature seen during the exposure sequence or any other homogeneous parameter at a temperature that can characterize the local heating of the part. To is the reference temperature of the representative elementary volume, REV, or layer.

This quantity

$$Δ {T}_{M}^{*}$$

determined for an the points M makes it possible to determine a thermal map of the part or parts to be produced. The thermal map can therefore associate with each point M of the path of the tool (here of the laser) a value representative of a temperature which can, for example, be a temperature rise.

According to one embodiment, the heat map is thus generated from a value (for example the temperature element

$$Δ {T}_{M}^{*} )$$

associated with each representative elementary volume (each REV being centered on a point M associated with the value reported in the heat map).

Thus, according to this embodiment, p=7 primary parameters are chosen, which are:
laser irradiance, I₀ (or absorbed irradiance I_{abs}=I₀. A with A material absorbance);
cumulative exposure time

$${t}_{expo}^{cumul}$$

lasing time t_{scan};
depth of dense material b, or the equivalent depth b(′);
thermal conductivity k;
thermal diffusivity α;
deviation from the reference temperature, or temperature rise,

$$Δ {T}_{M}^{*}$$

As previously indicated, these parameters relate to the laser pattern

$$( {t}_{expo}^{cumul} , {t}_{scan} , b , {b}^{′} ) ,$$

to the material (k, α), and to the laser (I₀). A primary parameter relates to the rise in temperature, which is the data point we are trying to determine.

These parameters are assumed to be linked together by a mathematical function g( ).

These 7 parameters depend on 4 fundamental units (mass, length, time and temperature).

According to the Vaschy-Buckingham theorem (or IT theorem), if a physical equation involves p physical variables, which depend on fundamental units u, then there is an equivalent equation involving p-u dimensionless variables constructed from the original variables.

In the present embodiment, there is therefore a mathematical function h( ) equivalent to the function g( ), involving p−u=3 independent dimensionless numbers, which can be denoted π₁, π₂, π₃. We can write:

$${π}_{1} = h ( {π}_{2} , {π}_{3} ) .$$

Subsequently, this function will be called the correlation function, since it allows the variations of the dimensionless parameters π₁, π₂, π₃ to be correlated.

Conventionally, by exploiting the properties of these 3 numbers, we can define:

$$\{ \begin{matrix}\begin{matrix}{π}_{1} = \frac{k . Δ {T}_{M}^{*}}{{I}_{a b s} . \sqrt{α . {t}_{scan}}} \\ {π}_{2} = \frac{\sqrt{α . {t}_{scan}}}{{b}^{′}}\end{matrix} \\ {π}_{3} = \frac{{t}_{expo}^{cumul}}{{t}_{scan}}\end{matrix}$$

We can define & the characteristic diffusion length, so that:

$$δ = 2 . \sqrt{α . {t}_{scan}}$$

The definition of dimensionless parameters can then be written:

$$\{ \begin{matrix}\begin{matrix}{π}_{1} = \frac{2 k . Δ {T}_{M}^{*}}{{I}_{a b s} . δ} \\ {π}_{2} = \frac{δ}{2 {b}^{′}}\end{matrix} \\ {π}_{3} = \frac{{t}_{expo}^{cumul}}{{t}_{scan}}\end{matrix}$$

Note that π₁ depends on the temperature TID calculated at the surface of a semi-infinite medium absorbing the intensity I_{abs} with a one-dimensional thermal flow. This temperature is especially described in Carslaw H. J., Jaeger, J. C., “Conduction of heat in solids”, Oxford University Press, 1959. It can be defined by the expression:

$${T}_{1 D} = \frac{{I}_{a b s} . δ}{k . \sqrt{π}} .$$

The definition of dimensionless parameters can then be rewritten:

$$\{ \begin{matrix}\begin{matrix}{π}_{1} = \frac{2}{\sqrt{π}} \cdot \frac{. Δ {T}_{M}^{*}}{{T}_{1 D}} \\ {π}_{2} = \frac{1}{2} \cdot \frac{δ}{{b}^{′}}\end{matrix} \\ {π}_{3} = \frac{{t}_{expo}^{cumul}}{{t}_{scan}}\end{matrix}$$

Thus, the 3 dimensionless parameters obtained after dimensional analysis can be described as follows:

π₁ is proportional to a normalized temperature rise. This quantity is unknown beforehand: It is the one that we want to calculate along the laser pattern in order to obtain the heat map.

π₂ is proportional to the normalized diffusion length. This number characterizes the ability of the part to dissipate heat locally. The smaller the depth of dense material b, or the equivalent depth b′, compared to the characteristic diffusion length δ, the less the part is able to dissipate heat locally (all other things being equal). As described above, this value can be calculated solely from the data structure describing the laser pattern (for example in a file), considering the fact that only the dense zones are traversed by vectors.

π₃ is proportional to the normalized exposure time. The more the cumulative duration of laser exposure

$${t}_{expo}^{cumul}$$

tends toward lasing time t_{scan}, the faster the accumulation of heat locally (all other things being equal). Just like π₂, this number can be calculated only from the data structure describing the laser pattern.

Using the equation π₁=h(π₂; π₃), stated above, π₁ can be expressed as a function of π₂ and π₃, in order to calculate the characteristic temperature rise

$$Δ {T}_{M}^{*}$$

along the laser pattern:

$$Δ {T}_{M}^{*} = {T}_{1 D} \cdot h ( \frac{δ}{{b}^{′}} , \frac{{t}_{expo}^{cumul}}{{t}_{scan}} )$$

This expression shows that the temperature rise

$$Δ {T}_{M}^{*}$$

is proportional to the temperature T_{1D}, weighted by a function of the normalized diffusion length δ/b′ and the normalized exposure time

$${t}_{expo}^{cumul} / {t}_{scan} .$$

In a step S3, which can be performed separately (for example upstream) from the simulation method S1-S4-S5-S6, it is sought to estimate the correlation function h( ) which links the dimensionless parameters.

This step can be called the calibration step since it involves relating the known values of a subset of dimensionless parameters to a correlation function to obtain the value of the unknown parameter, i.e., the one that depends on the rise in temperature.

Several methods can be used to obtain an estimate of this function.

According to one embodiment, the simulation is performed on the scale of representative elementary volumes associated with each simulation point.

For example, this estimate can be made by simulating the vectorization and the thermal behavior associated with the scale of the representative elementary volume, REV, by varying the different primary parameters of the additive manufacturing process within a range of values relevant to the capacities of the machines or the window of the additive manufacturing process implemented. It is thus possible to describe a space of relevant values and, for each n-tuple of the parameter space, it is possible to obtain by calculation or simulation the dimensionless parameters π₁, π₂, π₃.

The aim is to create a numerical experimental design with the objective of constructing a response surface making it possible to correlate the dimensionless parameters π₁, π₂, π₃. When a function h( ) is difficult to determine, it is possible to construct a database in which the dimensionless parameters π₁, π₂, π₃ are tabulated.

In other words, from these p-tuples of dimensionless parameter values, a general law can be determined (by linear approximation or the like, for example), or a table constituting a kind of chart whose knowledge of p−1 entries allows determining the last value of the p-tuple.

This simulation can be carried out by different methods of the prior art such as for example the finite difference method, the finite element method, the finite volume method, the discontinuous Galerkin (DG) method, etc.

Simulating vectorization at the scale of the representative elementary volume, REV, to correlate the dimensionless parameters with one another, instead of doing so at the scale of an entire layer, considerably reduces calculation times: Thus, the simulation can take a few minutes for a REV compared to a few hours, or even a few tens of hours, for an entire layer.

FIG. 5 illustrates the result of such a simulation set. Each point represents a simulation and has the value of the correlation function applied to the pair (π₂, π₃) on the x-axis and the value of the additional dimensionless parameter π₁ on the y-axis.

It will be noted that the points are approximately aligned for all the parametric configurations, and in particular for different materials (since, during the simulations, the types of materials and therefore the parameters k and x) were varied. This validates the universal character of the law of scale thus obtained. Therefore, if experiments are well designed, this simulation can be carried out only once and reused for different simulations of the thermal behavior of a part for production by additive manufacturing.

Thus, the computational aspects of the simulation are shifted to the construction of this chart. They can be carried out before its use and can be shared for several uses. These calculations no longer penalize the processing of the determination of the thermal behavior of a part to be produced.

This chart can therefore be built upstream and reused for a set of simulations of the thermal behavior of a part to be produced because of the universal nature of its values.

Following the determination of the values of the primary parameters in step S1, it is possible, in step S4, to calculate the values of the dimensionless parameters which do not depend on the rise in temperature ATM

In the embodiment described above, these parameters are the parameters π₂ and π₃.

This calculation can be carried out for all or part of the layers of the part to be produced.

Each layer considered is subdivided into representative elementary volumes, REV. The characteristic dimension of these and the distance between two representative elementary volumes depend on the spatial and temporal resolution desired for the analysis.

Each representative elementary volume contains portions of the laser pattern, forming segments between an entry point and an exit point in the REV (thus, as a reminder, FIG. 3a, shows the oriented segments [1; 2], [3; 4], [5; 6], [7; 8], [9; 10]).

The dimensionless parameters not dependent on the temperature rise for each REV can be calculated from these segments and without the use of the geometric model.

The calculation of the dimensionless parameter π₃ is direct: It depends on the values of the durations

$${t}_{expo}^{cumul}$$

and t_{scan}. The value of these durations depends solely on the layer considered.

The calculation of the dimensionless parameter π₂ depends on a set of layers: It is necessary to aggregate the information contained in the previous layers in the depth a of the REV, in particular, to sum all the lengths of vector portions allowing the volume of dense matter to be calculated.

In a step S5, it is possible to calculate the value of the dimensionless parameter which depends on the rise in temperature.

This parameter, π₁ here actually depends on the other dimensionless parameters and on the correlation function h( ), determined in step S3.

In a step S6, the temperature rise can be calculated

$$Δ {T}_{M}^{*}$$

from this additional dimensionless parameter π₁ depending on the temperature rise.

The set of values determined for the thermal rise ΔT*_{M} for a set of points M of the laser pattern can thus provide a heat map.

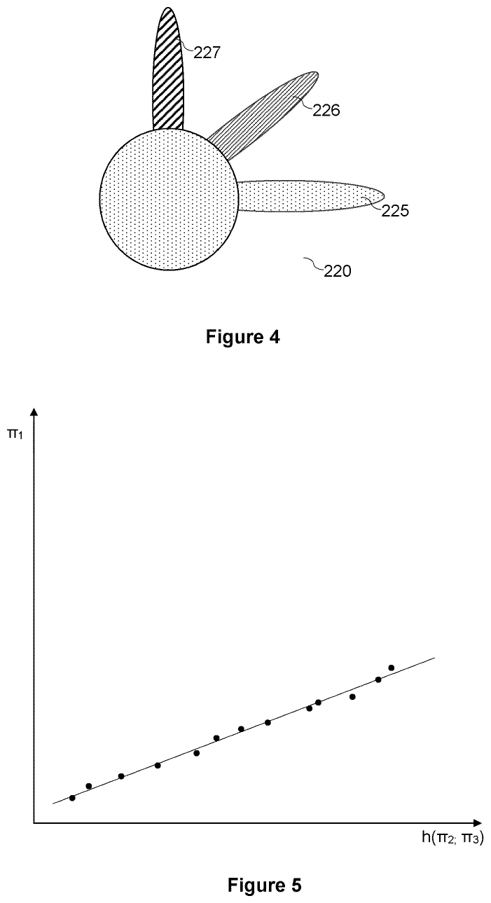

FIG. 4 is a very schematic illustration of such a heat map.

This figure shows a fictitious part to be produced 220. It is assumed that lasing is performed horizontally. The different filling patterns of the zones 225, 226, 227 correspond to distinct values of the temperature rise

$$Δ {T}_{M}^{*} .$$

Only 3 values are shown for the clarity of the figure, but in practice, the map can have a continuity of values (each corresponding to a gray level, in a graphical representation) or to a larger number of discrete values.

In zone 225 (shown by dotted lines), heating is minimal because the laser travels a great distance within the part (or parts, in general) before returning to the vicinity of the same point. The heat therefore has time to substantially dissipate between two laser passes in the same neighborhood (according to the predefined laser pattern).

In zone 227 (represented by bold hatching), the heating is strong because the laser makes very short back and forth trips in the part which has, in this zone, a very small dimension in the lasing direction. Between two laser passes, the heat does not have enough time to dissipate, and the temperature rises.

Zone 226 (represented by finer hatching) corresponds to a situation in between those of zones 225 and 227, in which the zone is oriented at 45° with regard to the laser pattern so that the travel time of the laser within this zone is longer than in zone 227, but not enough to allow sufficient heat dissipation.

This thermal mapping can be used to determine risk zones, i.e., those likely to give rise to hot spots that can cause protrusions on the surface, cracks, cavities (keyholes), or other anomalies on the part to be produced.

The determination of these risk zones can be carried out in various ways and results directly from the determination of the heat map.

For example, a threshold can be established beyond which a temperature difference is indicative of a risk zone.

The detection of one or more risk zones can trigger several actions on the part of the simulation device 100.

For example, these actions may include one or more of the following actions:
Alerting a user by highlighting the risk zone(s) on a graphic representation of the heat map;
Alerting the user to prevent additive manufacturing from being triggered as is;
Triggering an optimization of the configuration parameters of the additive manufacturing machine 200, in order to avoid, or reduce, the appearance of these risk zones.

Thus, the simulation device can be adapted to directly determine adaptations in the set of machine parameters, in order to optimize the heating and cooling cycles. In particular, it can be a question of homogenizing the heat input on the layers without penalizing manufacturing times too much.

According to one embodiment, the adaptation is performed individually for one or more segments of the laser pattern. This pattern can thus be adapted segment by segment. For example, a single segment can be adapted (if only that segment corresponds to a risk zone), or different parameters can be adapted for several segments, etc.

The parameters that can be adapted for this optimization include:
The power of the laser. The laser pattern can be retained but the power can be lowered on one or more segments of the laser pattern that correspond to risk zones.
The lasing speed. The laser pattern can be retained, but the laser speed can be increased on one or more segments that correspond to risk zones.
Pause times between two segments. For example, the laser pattern can be retained, but a pause time is added between two successive segments in or around a risk zone to let the zone cool.
The order of the segments. The laser pattern can be retained, but one or more segments can be skipped in a risk zone and then returned to later to allow the zone to cool in the meantime. This option is less detrimental to manufacturing time than the introduction of a pause time.
The length of the segments. In the case of a band laser strategy, the width of the bands can be enlarged in order to increase the time between two laser passes in the same zone. It is also possible to join two adjacent segments if one of them is too short.
The laser pattern, in its entirety, i.e. the arrangement of the path.
The geometry of the part to be produced.

This adaptation of parameters may, for example, comprise the modification of the data structure expressing the laser pattern. The lasing parameters (laser power, laser speed, laser beam diameter, irradiance profile, etc.) can be directly modified segment by segment in this data structure; the segment order can be changed, new lines can be added to insert a pause between two segments, etc.

According to one embodiment, the algorithm proposes several scenarios. Each scenario has advantages and disadvantages, which are arbitrated by the engineer according to the other constraints present in their specifications.

For example, a first scenario may be to modulate (only) the power as a function of the length of the vectors, so that the temperature at each point of the surface goes below the threshold previously set. This modulation is calculated automatically using the method presented here.

In this scenario, the minimum power proposed by the algorithm may be incompatible with the metallurgical specifications of the alloy produced. In this case, the engineer can set a minimum power, which forces the algorithm to adjust a second parameter (for example, pause times between two vectors), so as to respect the temperature threshold set.

Therefore, the engineer chooses a hybrid scenario, with two adjustment variables (laser power, and inter-vector pause time).

Another scenario may be to add pause times between all vectors. However, this solution may extend the manufacturing time beyond the specifications. In this case, the engineer can choose an alternative scenario, in which pause times are imposed only on the shortest vectors (with a threshold to be defined), and modulate the power and/or speed of the laser for the others.

In short, the algorithm must propose several scenarios, and the engineer can arbitrate by crossing the different constraints imposed on them. Each constraint imposed by the engineer (minimum power, maximum speed, etc.) is taken into account in a self-consistent manner by the algorithm, which adapts its scenarios accordingly.

Once modified, the data structure expressing the “new” laser pattern can be provided to the tool to enable the production of the part by additive manufacturing.

It should be noted that the description which has just been given relates to one embodiment. Numerous variants can be proposed.

In particular, the dimensionless parameters proposed, π₁, π₂, π₃ are not unique and other dimensionless parameters may be proposed, especially as a function of the primary parameters chosen to model the thermal behavior of the part to be produced. Indeed, if the primary parameters are changed, the dimensional analysis will provide a different set of dimensionless parameters.

In the embodiment described above, it was considered that the absorption process of the incident energy supplied by the laser was a surface phenomenon. Absorbed irradiance I_{abs} was therefore considered as the primary parameter. This hypothesis works particularly well for metal alloys irradiated by YAG lasers, in “conduction” mode. Alternatively, it can be considered that the irradiated material absorbs the incident radiation in volume (this is for example the case of ceramics irradiated by YAG lasers or, as a first approximation, that of metals in keyhole mode).

In this case, the absorbed irradiance I_{abs} (expressed in W/m²) may be replaced by a volumetric heat source Q_{abs} (expressed in W/m³). After dimensional analysis, we can calculate three dimensionless parameters π′₁, π′₂, π′₃:

$$\{ \begin{matrix}{π}_{1}^{′} = \frac{4 k \cdot Δ {T}_{M}^{*}}{{Q}_{a b s} \cdot {δ}^{2}} \\ {π}_{2}^{′} = \frac{δ}{2 {b}^{′}} \\ {π}_{3}^{′} = \frac{{t}_{e x p o}^{c u m u l}}{{t}_{s c a n}}\end{matrix}$$

Q_{abs} can be considered to be expressed as the product of the absorbed irradiance I_{abs} and a volume absorption coefficient β such that 1/β is homogeneous at an absorption thickness. We can then write:

$$\{ \begin{matrix}{π}_{1}^{′} = \frac{2 k \cdot Δ {T}_{M}^{*}}{{I}_{a b s} \cdot δ} \cdot \frac{2}{β \cdot δ} \\ {π}_{2}^{′} = {π}_{2} \\ {π}_{3}^{′} = {π}_{3}\end{matrix}$$

### Or:

$$\{ \begin{matrix}{π}_{1}^{′} = \frac{2}{β \cdot δ} \cdot {π}_{1} \\ {π}_{2}^{′} = {π}_{2} \\ {π}_{3}^{′} = {π}_{3}\end{matrix}$$

According to one embodiment, the volume absorption coefficient β can be considered as a primary parameter. Therefore, dimensional analysis can provide 4 dimensionless parameters, π₁″, π″₂, π″₃, π″₄. These dimensionless parameters can be expressed as:

$$\{ \begin{matrix}{π}_{1}^{″} = {π}_{1} = \frac{2 k \cdot Δ {T}_{M}^{*}}{{I}_{a b s} \cdot δ} \\ {π}_{2}^{″} = {π}_{2} = \frac{δ}{2 {b}^{′}} \\ {π}_{3}^{″} = {π}_{3} = \frac{{t}_{expo}^{cumul}}{{t}_{scan}} \\ {π}_{4}^{″} = β \cdot δ\end{matrix}$$

Moreover, in the embodiments described above, the heat source (laser) is modeled by irradiance alone (I_{abs}) or a heat source alone (Q_{abs}).

However, depending on the case of application, it may be desired to take into account the effect of the lasing speed V_{L} and that of the characteristic radius R_{L} of the energy source: In fact, a laser scan on a given surface is not strictly equivalent to an equivalent irradiance statically imposed on this same surface.

Five dimensionless parameters π₁, π₂, π₃, π₄, π₅ can then be determined:

$$\{ \begin{matrix}{π}_{1} = \frac{2}{\sqrt{π}} \cdot \frac{Δ {T}_{M}^{*}}{{T}_{1 D}} \\ {π}_{2} = \frac{1}{2} \cdot \frac{δ}{{b}^{′}} \\ {π}_{3} = \frac{{t}_{expo}^{cumul}}{{t}_{scan}} \\ {π}_{4} = \frac{{t}_{scan} \cdot {V}_{L}}{δ} \\ {π}_{3} = \frac{{R}_{L}}{δ}\end{matrix}$$

Similarly, the step S3 of determining a correlation function h( ) can be carried out in different ways.

Instead of the simulation described above, it is possible to implement an exact analytical resolution, especially for simple geometric and thermal configurations.

To do this, we can write the energy conservation equation at the surface of each representative elementary volume:

$$A \cdot {P}_{L} \cdot {t}_{expo}^{cumul} = {φ}_{e q} \cdot S \cdot {t}_{scan}$$

φ_{eq} represents the norm of the equivalent homogeneous heat flux absorbed at the surface S of the REV during the lasing time t_{scan}, such that the energy

$$A \cdot {P}_{L} \cdot {t}_{expo}^{cumul}$$

is absorbed by the representative elementary volume.

We can then deduce from this equation that

$${φ}_{e q} = \frac{A \cdot {P}_{L}}{S} \cdot \frac{{t}_{expo}^{cumul}}{{t}_{scan}}$$

By posing

$${I}_{abs}^{′} = {AP}_{L} / S ,$$

the power quality, we get:

$${φ}_{e q} = {I}_{abs}^{′} \cdot \frac{{t}_{expo}^{cumul}}{{t}_{scan}}$$

We can then assume that each representative elementary volume behaves like a one-dimensional medium of equivalent depth b′, with adiabatic edges. The mean temperature rise can be calculated by the expression:

$$Δ {T}_{M}^{*} = \frac{{φ}_{e q}}{k} \cdot {\sum }_{n = 0}^{∞} \{ ierfc ( 2 n \frac{{b}^{′}}{δ} ) + ierfc ( 2 ( n + 1 ) \frac{{b}^{′}}{δ} ) \}$$

We denote by ierfc( ) the integral function of the complementary error function of the Gaussian error function, erfc( ).

Other analytical solutions can be obtained by setting other different boundary conditions (Dirichlet temperature conditions, convection and radiation losses, etc.).

By combining the two preceding equations, we can obtain

$$Δ {T}_{M}^{*} = \frac{{I}_{abs}^{′} \cdot δ}{k} \cdot \frac{{t}_{e x p o}^{c u m u l}}{{t}_{s c a n}} \cdot {\sum }_{n = 0}^{∞} \{ ierfc ( 2 n \frac{{b}^{′}}{δ} ) + ierfc ( 2 ( n + 1 ) \frac{{b}^{′}}{δ} ) \}$$

Finally, by posing

$${T}_{1 D}^{′} = {I}_{abs}^{′} δ / k \sqrt{π} ,$$

we obtain:

$$Δ {T}_{M}^{*} = \sqrt{π} \cdot {T}_{1 D}^{′} \cdot \frac{{t}_{expo}^{uumul}}{{t}_{scan}} . {\sum }_{n = 0}^{∞} \{ ierfc ( 2 n \frac{{b}^{′}}{δ} ) + ierfc ( 2 ( n + 1 ) \frac{{b}^{′}}{δ} ) \}$$

Or

$$Δ {T}_{M}^{*} = {T}_{1 D}^{′} \cdot h ( \frac{δ}{{b}^{′}} , \frac{{t}_{expo}^{cumul}}{{t}_{scan}} )$$

With:

$$h ( \frac{δ}{{b}^{′}} , \frac{{t}_{e x p o}^{c u m u l}}{{t}_{s c a n}} ) = \sqrt{π} \cdot \frac{{t}_{expo}^{cumul}}{{t}_{scan}} . {\sum }_{n = 0}^{∞} \{ ierfc ( 2 n \frac{{b}^{′}}{δ} ) + ierfc ( 2 ( n + 1 ) \frac{{b}^{′}}{δ} ) \}$$

The advantage of an analytical solution compared to the estimation of the h( ) function by simulation is that it saves computational costs. However, this exact analytical solution represents a simplified geometric configuration with boundary conditions that are not very representative of those of the method.

Still another way of doing this is to use experimental data instead of numerical data (for example, infrared thermographic measurements, or any other in situ thermal measurement), acquired during the manufacture of technological calibration test pieces (or samples) or complete parts.

The advantage of technological test pieces compared to complete parts is that they are designed to have geometrical characteristics representative of those found on the industrial parts whose manufacture is sought, while being less complex and less expensive to manufacture than these parts.

Thus, it is possible to correlate thermal measurements to dimensionless parameters along the laser pattern and thus estimate a correlation function h( ).

The advantage of experimental data over numerical solutions is their reliability (within the inherent limits of measuring instruments). However, numerical simulation saves material and time of use of additive manufacturing machines.

Of course, the present invention is not limited to the examples and to the embodiment described and shown but rather is defined by the claims. In particular, it is capable of numerous variants accessible to the person skilled in the art.

1. A method of determining the thermal behavior of a part for the production by additive manufacturing using at least one tool, comprising, for a set of points of a path of said tool intended for said production, steps implemented by a processing unit of an optimization device (100) of:
determining (S1) values of a set of primary parameters relating to said additive manufacturing production;
determining (S4, S5) values of a reduced set of dimensionless parameters, as a function of the values of said set of primary parameters and a correlation function linking said dimensionless parameters;
generating (S6) a heat map for at least one layer of said part, as a function of said dimensionless parameters, said heat map being recorded in digital format and associating a value representative of a temperature with said points,
determining at least one risk zone within said heat map;
adapting at least one parameter of said tool (200) as a function of said at least one risk zone, said at least one parameter optionally being a parameter of said path.

2. The method according to claim 1, wherein said determination of values of a reduced set of dimensionless parameters comprises determining (S4) a subset of dimensionless parameters from said primary parameters, and determining (S5) a dimensionless parameter dependent on a temperature rise from said subset and the correlation function, said dimensionless parameter dependent on a temperature rise being included in the determined reduced set of dimensionless parameters.

3. The method according to claim 2, wherein said correlation function is estimated (S3) by varying values for the primary parameters of the set of primary parameters and simulating an associated temperature rise.

4. The method according to claim 1, wherein said at least one tool is at least one laser and said primary parameters comprise an irradiance of said at least one laser and/or a cumulative exposure time and/or a lasing time and/or a dense material depth and/or an equivalent depth and/or a thermal conductivity and/or a thermal diffusivity.

5. The method according to claim 4, wherein there are 3 of said dimensionless parameters, π₁, π₂, π₃ and they are expressed:
$$\{ \begin{matrix}{π}_{1} = \frac{2}{\sqrt{π}} \cdot \frac{\cdot Δ {T}_{M}^{*}}{{T}_{1 D}} \\ {π}_{2} = \frac{1}{2} \cdot \frac{δ}{{b}^{′}} \\ {π}_{3} = \frac{{t}_{expo}^{cumul}}{{t}_{scan}}\end{matrix}$$
with
$${T}_{1 D} = {I}_{a b s} \cdot δ / k \cdot \sqrt{π} , Δ {T}_{M}^{*}$$
being said value representing a temperature at a point of said set, I_{abs} being said irradiance, δ being a characteristic diffusion length dependent on said thermal diffusivity, k being said thermal conductivity, b′ being said equivalent depth,
$${t}_{expo}^{cumul}$$
being said cumulative exposure time, and t_{scan} being said lasing time.

6. The method according to claim 4, wherein said primary parameters further comprise a lasing speed and a characteristic radius of said tool.

7. The method according to claim 1, wherein there are 5 of said dimensionless parameters, π₁, π₂, π₃, π₄, π₅ and they are expressed:
$$\{ \begin{matrix}{π}_{1} = \frac{2}{\sqrt{π}} \cdot \frac{Δ {T}_{M}^{*}}{{T}_{1 D}} \\ {π}_{2} = \frac{1}{2} - \frac{δ}{{b}^{′}} \\ {π}_{3} = \frac{{t}_{expo}^{cumul}}{{t}_{scan}} \\ {π}_{4} = \frac{{t}_{scan} \cdot {V}_{L}}{δ} \\ {π}_{3} = \frac{{R}_{L}}{δ}\end{matrix}$$
with
$${T}_{1 D} = {I}_{a b s} \cdot δ / k \cdot \sqrt{π} , Δ {T}_{M}^{*}$$
being said value representing a temperature at a point in said set, I_{abs} being said irradiance, δ being a characteristic diffusion length dependent on said thermal diffusivity, k being said thermal conductivity, b′ being said equivalent depth,
$${t}_{expo}^{cumul}$$
being said cumulative exposure time, t_{scan} being said lasing time, R_{L} being said characteristic radius and V_{L} being said lasing speed.

8. The method according to claim 1, wherein the determinations of values of a set of primary parameters and of values of a reduced set of dimensionless parameters are made from a modeling based on a set of representative elementary volumes, said heat map being generated from a value associated with each representative elementary volume.

9. The method according to claim 1, wherein said simulation is performed on the scale of representative elementary volumes associated with each simulation point.

10. The method according to claim 1, wherein said adaptation is performed individually for at least one segment of said path.

11. The method according to claim 10, wherein said adaptation comprises an adaptation of one or more of the following parameters: a power of a laser of said tool, a lasing speed, a pause time between two segments of said path, an order of the segments of said path, the length of said segments, an arrangement of said path and a geometry of the part.

12. The method according to claim 1, wherein said adaptation comprises a modification of a data structure expressing said path, said data structure being intended to be provided to said tool.

13. A computer-readable media support comprising instructions for carrying out a method according to claim 1.

14. A system comprising a machine (200) for production by additive manufacturing using at least one tool, adapted to produce a part from a path of said tool, and comprising an optimization device configured to, for a set of points of said path, implement steps of:
determining values of a set of primary parameters relating to said additive manufacturing production;
determining values of a reduced set of dimensionless parameters, as a function of the values of said set of primary parameters and a correlation function linking said dimensionless parameters;
generating a heat map for at least one layer of said part, as a function of said dimensionless parameters, said heat map being recorded in digital format and associating a value representative of a temperature with said points;
determining at least one risk zone within said heat map,
adapting at least one parameter of said machine (200) as a function of said at least one risk zone, said at least one parameter optionally being a parameter of said path.
